(19) United States
(12) Patent Application Publication
(10) Pub. No.: US 2024/0426554 A1
(43) Pub. Date: Dec. 26, 2024

(54) HEAT TREATMENT SYSTEM AND ATMOSPHERE SUBSTITUTION STRUCTURE OF HEAT TREATMENT FURNACE

(71) Applicants: NGK INSULATORS, LTD., Nagoya-Shi (JP); NGK KILNTECH, CORPORATION, Nagoya-Shi (JP)

(72) Inventors: Terukazu IWATA, Nagoya-Shi (JP); Tomoaki OYAMA, Nagoya-Shi (JP); Kazuhiko ARIMA, Nagoya-Shi (JP)

(73) Assignees: NGK INSULATORS, LTD., Nagoya-Shi (JP); NGK KILNTECH, CORPORATION, Nagoya-Shi (JP)

(21) Appl. No.: 18/825,110

(22) Filed: Sep. 5, 2024

Related U.S. Application Data
(63) Continuation of application No. PCT/JP2023/017800, filed on May 11, 2023.

(30) Foreign Application Priority Data
May 31, 2022 (JP) 2022-088553

(51) Int. Cl. F27D 1/18; F27B 9/24; F27D 3/12

(52) U.S. Cl. CPC F27D 1/1858; F27B 9/24; F27D 3/12; F27D 2001/1891

(57) ABSTRACT

A heat treatment system may include: a first supply device; a first heat treatment furnace; a first recovery device; a second supply device; a second heat treatment furnace; and a second recovery device. The first heat treatment furnace may include: a heat treatment unit; and a first conveyor configured to convey the saggar in a first direction. The second heat treatment furnace may include: a heat treatment unit; and a second conveyor configured to convey the saggar in a second direction opposite to the first direction. Each of the first and second heat treatment furnaces may further include a substitution unit configured to isolate the heat treatment unit from outside of an exit. The substitution unit may include doors constituted of a heat insulating material, and disposed between the heat treatment unit and the substitution unit and between the substitution unit and the exit.

### CROSS-REFERENCE TO RELATED APPLICATION

The present application claims priority to Japanese Patent Application No. 2022-088553, filed on May 31, 2022, the entire contents of which are incorporated herein by reference.

### TECHNICAL FIELD

The art disclosed herein relates to a technique of heat-treating a treatment object.

### BACKGROUND ART

A treatment object may be heat-treated using a heat treatment furnace (e.g., Roller Hearth kiln, pusher kiln). Generally, in the heat treatment furnace, improvement in productivity and reduced use of atmospheric gas have been demanded. For example, Japanese Patent Application Publication No. 2020-085367 describes a heat treatment system including a heat treatment furnace configured to convey a treatment object in a forward direction and another heat treatment furnace configured to convey the treatment object in a reverse direction. In the heat treatment system of Japanese Patent Application Publication No. 2020-085367, the treatment object is accommodated in a saggar and conveyed in the heat treatment furnaces, and the treatment object is heat-treated while the saggar is being conveyed through the heat treatment furnaces. The saggar is repeatedly used for heat-treating the treatment object. In the heat treatment system of Japanese Patent Application Publication No. 2020-085367, an exit of the heat treatment furnace which conveys the treatment object in the forward direction is disposed near an entrance of the heat treatment furnace that conveys the treatment object in the reverse direction, and an exit of the heat treatment furnace that conveys the treatment object in the reverse direction is disposed near an entrance of the heat treatment furnace that conveys the treatment object in the forward direction. Due to this, the saggar can be conveyed to the next heat treatment furnace while a temperature of the saggar is kept high. Due to this, time for raising the temperature of the saggar can be shortened, and a length of the heat treatment furnaces can thereby be shortened. Accordingly, use of atmospheric gas in the heat treatment furnaces can be reduced.

### SUMMARY

Generally, a substitution unit configured to substitute atmosphere between inside of a heat treatment furnace (i.e., heat treatment unit configured to heat-treat a treatment object) and outside of the heat treatment furnace is arranged on an exist side of the heat treatment furnace. The substitution unit is installed with doors configured to be opened and closed at a boundary between the heat treatment unit and the substitution unit and at a boundary between the substitution unit and outside of the heat treatment furnace. The substitution unit needs to be sealed well by the doors during substitution of the atmosphere. In the heat treatment system of Japanese Patent Application Publication No. 2020-085367, however, the saggar is conveyed out of the heat treatment furnace while the temperature of the saggar is high, so that the high-temperature saggar is conveyed into the next heat treatment furnace. Due to this, a temperature within the substitution unit becomes high as well, by which it has been difficult to secure sealing property by the doors of the substitution unit.

The present teachings provide an art configured to allow a saggar to be conveyed out of a heat treatment furnace with a temperature of the saggar kept high.

In a first aspect of the technology disclosed herein, a heat treatment system may comprise: a first supply device; a first heat treatment furnace; a first recovery device; a second supply device; a second heat treatment furnace; and a second recovery device. The first supply device may be disposed near the second recovery device and configured to supply a treatment object to a saggar conveyed from the second recovery device. The first heat treatment furnace may comprise: an entrance disposed near the first supply device and through which the saggar supplied with the treatment object by the first supply device is conveyed into the first heat treatment furnace; an exit through which the entered saggar is conveyed out of the first heat treatment furnace; a heat treatment unit disposed between the entrance and the exit of the first heat treatment furnace, and configured to heat-treat the treatment object supplied in the saggar while the saggar is conveyed from the entrance to the exit of the first heat treatment furnace; and a first conveyor configured to convey the saggar in a first direction, the first direction being a direction from the entrance to the exit of the first heat treatment furnace. The first recovery device may be disposed near the exit of the first heat treatment furnace and configured to recover the treatment object that has been heat-treated in the first heat treatment furnace from the saggar. The second supply device may be disposed near the first recovery device and configured to supply a new treatment object to the saggar from which the treatment object has been recovered by the first recovery device. The second heat treatment furnace may comprise: an entrance disposed near the second supply device and through which the saggar supplied with the treatment object by the second supply device is conveyed into the second heat treatment furnace; an exit through which the entered saggar is conveyed out of the second heat treatment furnace; a heat treatment unit disposed between the entrance and the exit of the second heat treatment furnace, and configured to heat-treat the treatment object supplied in the saggar while the saggar is conveyed from the entrance to the exit of the second heat treatment furnace; and a second conveyor configured to convey the saggar from the entrance to the exit of the second heat treatment furnace in a second direction opposite to the first direction. The second recovery device may be disposed near the exit of the second heat treatment furnace and configured to recover the treatment object that has been heat-treated in the second heat treatment furnace from the saggar. Each of the first heat treatment furnace and the second heat treatment furnace may further comprise a substitution unit disposed between the heat treatment unit of a corresponding heat treatment furnace and the exit of the corresponding heat treatment furnace, and configured to isolate the heat treatment unit of the corresponding heat treatment furnace from outside of the exit of the corresponding heat treatment furnace. The substitution unit may comprise doors constituted of a heat insulating material and configured to be opened and closed, and disposed between the heat treatment unit and the substitution unit of the corresponding heat treatment furnace and between the substitution unit and the exit of the corresponding heat treatment furnace.

An atmosphere substitution structure disclosed herein may be disposed in a heat treatment furnace comprising a heat treatment unit and configured to maintain atmosphere in an internal space of the heat treatment unit, wherein the heat treatment furnace comprises: an entrance through which a saggar supplied with a treatment object is conveyed into the heat treatment furnace; the heat treatment unit configured to heat-treat the treatment object supplied in the saggar that has been conveyed through the entrance; an exit through which the saggar supplied with the treatment object that has been heat-treated by the heat treatment unit is conveyed out of the heat treatment furnace; and a first conveyor configured to convey the saggar from the entrance to the exit. The atmosphere substitution structure may comprise: a substitution chamber disposed between the heat treatment unit and the exit; a first door disposed between the substitution chamber and the heat treatment unit; and a second door disposed between the substitution chamber and the exit. Each of the first door and the second door may be constituted of a heat insulating material.

### BRIEF DESCRIPTION OF DRAWINGS

FIG. 1 is a top view showing a schematic configuration of a heat treatment system according to a present embodiment.

FIG. 2 is a schematic configuration of a first heat treatment furnace and a vertical cross-sectional view when the heat treatment furnace is cut along a plane parallel to a conveying direction of a treatment object.

FIG. 3 is a cross-sectional view along a III-III line in FIG. 2.

FIG. 4 is a block diagram showing a configuration of a control system of the first heat treatment furnace.

FIG. 5 is a side view showing a schematic configuration of an exit-side atmosphere substitution structure arranged on an exist side of a heat treatment unit.

FIG. 6 is a front view showing a configuration of a door.

FIG. 7 is a cross-sectional view along a VII-VII line in FIG. 6.

FIG. 8 is a side view showing configuration of a pressing device in which (a) shows a state where the pressing device is pressing the door and (b) shows a state where the pressing device is not pressing the door.

FIG. 9 is a front view showing configurations of the door, chains, and a shaft.

### DETAILED DESCRIPTION

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the present disclosure. Furthermore, each of the additional features and teachings disclosed below may be utilized separately or in conjunction with other features and teachings to provide improved heat treatment systems and atmosphere substitution structures, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Some of the features characteristic to below-described embodiments will herein be listed. It should be noted that the respective technical elements are independent of one another, and are useful solely or in combinations. The combinations thereof are not limited to those described in the claims as originally filed.

In a first aspect of the technology disclosed herein, a heat treatment system may comprise: a first supply device; a first heat treatment furnace; a first recovery device; a second supply device; a second heat treatment furnace; and a second recovery device. The first supply device may be disposed near the second recovery device and configured to supply a treatment object to a saggar conveyed from the second recovery device. The first heat treatment furnace may comprise: an entrance disposed near the first supply device and through which the saggar supplied with the treatment object by the first supply device is conveyed into the first heat treatment furnace; an exit through which the entered saggar is conveyed out of the first heat treatment furnace; a heat treatment unit disposed between the entrance and the exit of the first heat treatment furnace, and configured to heat-treat the treatment object supplied in the saggar while the saggar is conveyed from the entrance to the exit of the first heat treatment furnace; and a first conveyor configured to convey the saggar in a first direction, the first direction being a direction from the entrance to the exit of the first heat treatment furnace. The first recovery device may be disposed near the exit of the first heat treatment furnace and configured to recover the treatment object that has been heat-treated in the first heat treatment furnace from the saggar. The second supply device may be disposed near the first recovery device and configured to supply a new treatment object to the saggar from which the treatment object has been recovered by the first recovery device. The second heat treatment furnace may comprise: an entrance disposed near the second supply device and through which the saggar supplied with the treatment object by the second supply device is conveyed into the second heat treatment furnace; an exit through which the entered saggar is conveyed out of the second heat treatment furnace; a heat treatment unit disposed between the entrance and the exit of the second heat treatment furnace, and configured to heat-treat the treatment object supplied in the saggar while the saggar is conveyed from the entrance to the exit of the second heat treatment furnace; and a second conveyor configured to convey the saggar from the entrance to the exit of the second heat treatment furnace in a second direction opposite to the first direction. The second recovery device may be disposed near the exit of the second heat treatment furnace and configured to recover the treatment object that has been heat-treated in the second heat treatment furnace from the saggar. Each of the first heat treatment furnace and the second heat treatment furnace may further comprise a substitution unit disposed between the heat treatment unit of a corresponding heat treatment furnace and the exit of the corresponding heat treatment furnace, and configured to isolate the heat treatment unit of the corresponding heat treatment furnace from outside of the exit of the corresponding heat treatment furnace. The substitution unit may comprise doors constituted of a heat insulating material and configured to be opened and closed, and disposed between the heat treatment unit and the substitution unit of the corresponding heat treatment furnace and between the substitution unit and the exit of the corresponding heat treatment furnace.

In the above-described heat treatment system, the doors constituted of the heat insulating materials are disposed at the entrance and the exit of each substitution unit. By the doors being constituted of a heat insulating material, heat resistance of the doors can be ensured and thermal deformation of the doors can be suppressed. Due to this, the heat treatment unit and the outside of each heat treatment furnace can be isolated from each other by each substitution unit, and air-tightness (sealing property) of the heat treatment unit can be ensured. Accordingly, the saggar can be conveyed to each substitution unit with the temperature of the saggar being high, and thus the saggar can be conveyed to the outside of each heat treatment furnace with the temperature of the saggar being high.

In a second aspect of the technology disclosed herein according to the first aspect, each of the first heat treatment furnace and the second heat treatment furnace may further comprise: a contact surface disposed between the heat treatment unit and at least one of the doors disposed in the substitution unit, and contacting an entire periphery of the at least one of the doors when the at least one of the doors is closed, and a pressing device disposed outside the substitution unit and configured to press the door toward the contact surface when the door is closed. According to the above configuration, the pressing device can seal between the door and the heat treatment unit. Due to this, airtightness of the heat treatment unit by the door can be improved, and thus the atmosphere in the heat treatment unit can be secured.

In a third aspect of the technology disclosed herein according to the second aspect, the contact surface may comprise a seal sealing between the door and the contact surface. The seal may be constituted of a fiber-based seal material. According to the above configuration, heat resistance of the seal can be secured.

In a fourth aspect of the technology disclosed herein according to the second or third aspect, the pressing device may comprise: a pressing portion configured to contact the door; a cylinder disposed closer to the exit than the pressing portion and configured to press the pressing portion; and a coupling portion configured to connect the pressing portion and the cylinder. The pressing portion and the coupling portion may be constituted of a heat-resistant material. According to the above configuration, the cylinder and the pressing portion are connected by the coupling portion, and thus the cylinder can be arranged at a spot remote from the door the temperature of which becomes high. Accordingly, the cylinder can be suppressed from being affected by heat.

In a fifth aspect of the technology disclosed herein according to the fourth aspect, the pressing portion may be constituted of a ceramic material. The pressing portion makes contact with the door, the temperature of which becomes high. Heat resistance of the pressing portion can be improved by making the pressing portion with a ceramic material.

In a sixth aspect of the technology disclosed herein according to the fourth or fifth aspect, each of the first heat treatment furnace and the second heat treatment furnace may further comprise a chain connected to an upper end of the at least one of the doors disposed in the substitution unit and supporting the at least one of the doors. According to the above configuration, the door is freely hung by the chain. Due to this, even when the door is thermally deformed, sealing property when the door is pressed by the pressing device can be ensured.

In a seventh aspect of the technology disclosed herein according to the sixth aspect, each of the first heat treatment furnace and the second heat treatment furnace may further comprise: a shaft configured to wind up the chain by rotating the shaft in a third direction and wind down the chain by rotating the shaft in a fourth direction opposite to the third direction; and a drive device configured to rotate the shaft. The shaft may be disposed above the chain so that its axis is horizontal and perpendicular to a conveying direction. The door may move upward as the shaft winds up the chain and move downward as the shaft winds down the chain. According to such configuration, the shaft which winds up and down the chain has its axis set to a direction which is horizontal and perpendicular to the conveying direction (i.e., set to a lateral direction). One end of the chain is connected to the door, and another end of the chain is connected to the shaft disposed outside the substitution unit. Due to this, in a state where the door is opened, the space within the heat treatment unit is in communication with a space outside the substitution unit (heat treatment furnace) via a space where the chain is disposed. In order to secure the air-tightness of the heat treatment unit, it is preferable to seal the space where the chain is disposed from the space outside the substitution unit. Since the configuration of the shaft winding up the chain is implemented, the shaft which is a driver only performs rotary motion about its axis, and thus an area of a section which needs to be sealed can be made smaller. Contrary to this, if, unlike the above configuration, a configuration where a cylinder is used to move the chain up and down is implemented, the cylinder which is the driver needs to have a stroke length conforming to a dimension of the door, as a result of which an area of a section which needs to be scaled would be increased. Consequently, according to the above configuration, the area of the section which needs to be sealed can be made smaller.

In an eighth aspect of the technology disclosed herein according to the sixth aspect, the door may be configured to be opened by moving downward. An upper part of the door is susceptible to heat. Because the door is opened by being moved downward, the door becomes less susceptible to heat when the door is open.

In a ninth aspect of the technology disclosed herein according to the first aspect, each of the first heat treatment furnace and the second heat treatment furnace may further comprise an entrance-side substitution unit disposed between the heat treatment unit of a corresponding heat treatment furnace and the entrance of the corresponding heat treatment furnace, and configured to isolate the heat treatment unit of the corresponding heat treatment furnace from an outside of the entrance of the corresponding heat treatment furnace. The entrance-side substitution unit may comprise doors constituted of a heat insulating material and configured to be opened and closed, and disposed between the heat treatment unit and the entrance-side substitution unit of the corresponding heat treatment furnace and between the entrance-side substitution unit and the entrance of the corresponding heat treatment furnace. According to such configuration, in addition to the exit side of each heat treatment furnace, the substitution unit is disposed also on the entrance side of each heat treatment furnace. Due to this, the substitution units are arranged both on the entrance side and the exit side of each heat treatment furnace, and thus the substitution unit can isolate the heat treatment unit and the outside of the corresponding heat treatment furnace from each other both on the entrance side and the exit side of the corresponding heat treatment furnace. Further, the doors constituted of the heat insulating material are arranged at the entrance and the exit in the entrance-side substitution units also, and thus heat resistance of the doors can be ensured, by which thermal deformation of the doors can be suppressed. Due to this, the saggar at a high temperature can be conveyed from outside into the entrance-side substitution unit, and thus the high-temperature saggar conveyed into the entrance-side substitution unit can be conveyed into the inside of the corresponding heat treatment furnace.

An atmosphere substitution structure disclosed herein may be disposed in a heat treatment furnace comprising a heat treatment unit and configured to maintain atmosphere in an internal space of the heat treatment unit, wherein the heat treatment furnace comprises: an entrance through which a saggar supplied with a treatment object is conveyed into the heat treatment furnace; the heat treatment unit configured to heat-treat the treatment object supplied in the saggar that has been conveyed through the entrance; an exit through which the saggar supplied with the treatment object that has been heat-treated by the heat treatment unit is conveyed out of the heat treatment furnace; and a conveyor configured to convey the saggar from the entrance to the exit. The atmosphere substitution structure may comprise: a substitution chamber disposed between the heat treatment unit and the exit; a first door disposed between the substitution chamber and the heat treatment unit; and a second door disposed between the substitution chamber and the exit. Each of the first door and the second door may be constituted of a heat insulating material.

In the above-described atmosphere substitution structure, the first door constituted of a heat insulating material is disposed at the entrance of the substitution chamber and the second door constituted of a heat insulating material is disposed at the exit of the substitution chamber. Due to this, same operation and effect as those of the above-described heat treatment system can be brought forth.

### Embodiment

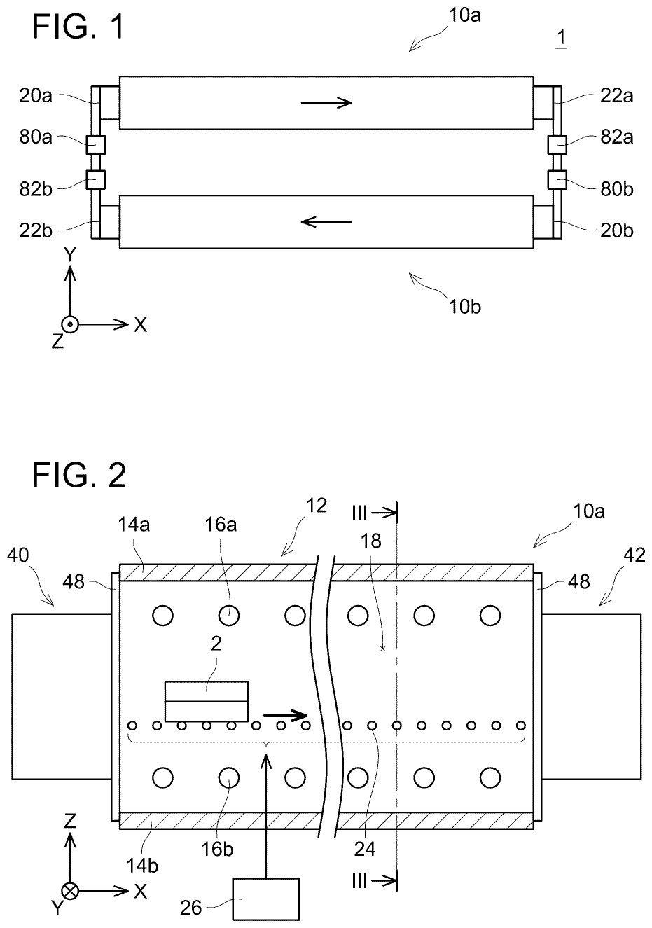

With reference to drawings, a heat treatment system 1 according to the present embodiment will be described. As illustrated in FIG. 1, the heat treatment system 1 comprises a first supply device 80a, a first heat treatment furnace 10a, a first recovery device 82a, a second supply device 80b, a second heat treatment furnace 10b, and a second recovery device 82b. The heat treatment system 1 heat-treats a treatment object accommodated in a saggar 2 (see FIG. 2). In the present embodiment, a treatment object accommodated in the saggar 2 is lithium-ion positive electrode material powder. The heat treatment system 1 according to the present embodiment is configured such that the saggar 2 circulates between the first supply device 80a, the first heat treatment furnace 10a, the first recovery device 82a, the second supply device 80b, the second heat treatment furnace 10b, and the second recovery device 82b. The treatment object is heat-treated while the saggar 2 is being conveyed in the first heat treatment furnace 10a or in the second heat treatment furnace 10b.

Firstly, the first supply device 80a and the second supply device 80b will be described. The first supply device 80a is arranged between the second recovery device 82b and the first heat treatment furnace 10a (in particular, an entrance 20a of the first heat treatment furnace 10a). The first supply device 80a supplies a new treatment object to the saggar 2 which is empty and from which the treatment object was recovered by the second recovery device 82b. The second supply device 80b is disposed between the first recovery device 82a and the second heat treatment furnace 10b (in particular, an entrance 20b of the second heat treatment furnace 10b). The second supply device 80b supplies a new treatment object to the saggar 2 which is empty and from which the treatment object was recovered by the first recovery device 82a. The first supply device 80a and the second supply device 80b have a same configuration as each other. Hereinafter, therefore, the first supply device 80a will be described.

The first supply device 80a is a device configured to supply a treatment object (i.e., powder) into the saggar 2. Here, the first supply device 80a simply needs to be configured to supply the powder into the saggar 2, and a specific configuration thereof is not specifically limited. For example, the first supply device 80a comprises a supply part and a leveling part. The supply part is configured to supply the powder into the saggar 2. Specifically, the supply part comprises a supply port for dropping the powder into the saggar 2 from above the saggar 2. The supply port is arranged so as to be positioned above a center of the saggar 2 when the saggar 2 is arranged in the supply part. The supply part comprises a positioning device, and the positioning device positions the saggar 2 conveyed to the supply part below the supply port. The positioning device has a contact surface with the saggar 2 and this contact surface is constituted of a ceramic material. Due to this, heat resistance of the positioning device can be ensured, and the saggar 2 the temperature of which is high can be positioned in the supply part. Here, a plurality of supply ports may be disposed in the supply part. Because the supply part is configured to supply the powder into the saggar 2 by dropping the powder from above, an upper surface of the powder in the saggar 2 is raised upward at a position below the supply port. The leveling part is configured to level the powder supplied in the saggar 2 by the supply part. Specifically, the leveling part is configured to level the upper surface of the powder by pressing the upper surface of the powder in the saggar 2 by a planar side surface. The upper surface of the powder accommodated in the saggar 2 becomes substantially horizontal by being levelled by the leveling part. Also, the first supply device 80a has its component (e.g., frame) positioned above the saggar 2 is furnished with a heat insulating material for heat barrier. Due to this, the first supply device 80a can secure heat resistance against the high-temperature saggar 2, and thus can supply the powder to the high-temperature saggar 2.

Next, the first heat treatment furnace 10a and the second heat treatment furnace 10b will be described. The first heat treatment furnace 10a and the second heat treatment furnace 10b are configured to heat-treat the treatment object in the saggar 2.

As illustrated in FIGS. 2 to 4, the first heat treatment furnace 10a comprises a heat treatment unit 12, an entrance-side atmosphere substitution structure 40, an exit-side atmosphere substitution structure 42, a conveying device (24, 26), and a controller 28. The first heat treatment furnace 10a is configured to heat-treat the treatment object accommodated in the saggar 2 while the saggar 2 is being conveyed in the heat treatment unit 12 by the conveying device (24, 26).

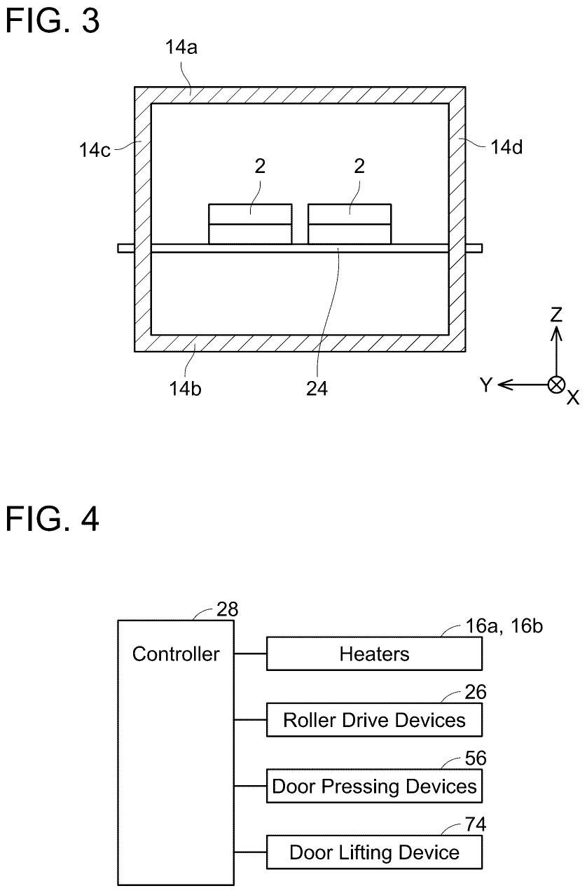

The heat treatment unit 12 has an outer shape of a substantially cuboid, and is surrounded by a ceiling wall 14a, a bottom wall 14b, side walls 14c, 14d, and two doors 48 to be described later. As illustrated in FIG. 2, the ceiling wall 14a is disposed parallel to the bottom wall 14b (i.e., parallel to a X-Y plane). As illustrated in FIG. 3, the side walls 14c, 14d are disposed parallel to a conveying direction and also perpendicular to the ceiling wall 14a and the bottom wall 14b (i.e., parallel to a X-Z plane). As illustrated in FIG. 2, the entrance of the heat treatment unit 12 is isolated from the entrance-side atmosphere substitution structure 40 by one of the two doors 48, and the exit of the heat treatment unit 12 is isolated from the exit-side atmosphere substitution structure 42 by the other door 48. In the heat treatment unit 12, pluralities of heaters 16a, 16b and a plurality of conveying rollers 24 are disposed. The heaters 16a are arranged at predetermined intervals in the conveying direction at positions above the conveying rollers 24, and the heaters 16b are arranged at predetermined intervals in the conveying direction at positions below the conveying rollers 24. By the heaters 16a, 16b generating heat, a space 18 in the heat treatment unit 12 is heated, thereby the treatment object accommodated in the saggar 2 is also heated.

The entrance-side atmosphere substitution structure 40 is disposed adjacent to the heat treatment unit 12 on an entrance side, and the exit-side atmosphere substitution structure 42 is disposed adjacent to the heat treatment unit 12 on an exit side. Here, configurations of the entrance-side atmosphere substitution structure 40 and the exit-side atmosphere substitution structure 42 will be described in detail later.

The conveying device (24, 26) comprises the plurality of conveying rollers 24 and a roller drive device 26. The conveying rollers 24 are configured to convey the saggar 2. The conveying device (24, 26) is configured to convey the saggar 2 from the entrance 20a of the first heat treatment furnace 10a to the entrance-side atmosphere substitution structure 40 and further pass the saggar 2 through the entrance-side atmosphere substitution structure 40 so as to be conveyed into the heat treatment unit 12. The conveying device (24, 26) is configured to then convey the saggar 2 from the heat treatment unit 12 into the exit-side atmosphere substitution structure 42 and further pass the saggar 2 through the exit-side atmosphere substitution structure 42 so as to be conveyed through an exit 22a of the first heat treatment furnace 10a to outside. In the first heat treatment furnace 10a, the conveying device (24, 26) conveys the saggar 2 in a +X direction.

Each of the conveying rollers 24 is cylindrical, and its axis extends in a direction perpendicular to the conveying direction (i.e., Y direction). All the plural conveying rollers 24 have a same diameter, and are disposed at a certain pitch at equal intervals in the conveying direction. Each of the conveying rollers 24 is supported rotatably about its axis, and is configured to rotate by driving force from the roller drive device 26 being transmitted thereto. The roller drive device 26 is a driver device (e.g., motor) configured to drive the conveying rollers 24. The roller drive device 26 is connected to the conveying rollers 24 via a power transmission mechanism. The conveying rollers 24 are configured to rotate when the driving force of the roller drive device 26 is transmitted to the conveying rollers 24 via the power transmission mechanism (e.g., mechanism by sprocket and chain).

As illustrated in FIG. 3, in the present embodiment, the saggars 2 are conveyed with the plural saggars 2 stacked in the up-down direction and the plural saggars 2 aligned in a direction perpendicular to the conveying direction (e.g., Y direction in FIG. 3) on the conveying rollers 24. The conveying device (24, 26) is configured to convey the plural saggars 2 arranged side-by-side in the Y direction at the same time into the heat treatment unit 12, with the saggars 2 arranged side-by-side in the Y direction aligned when conveying the saggars 2 from the entrance-side atmosphere substitution structure 40 into the heat treatment unit 12. Likewise, the conveying device (24, 26) is configured to convey the plural saggars 2 arranged side-by-side in the Y direction at the same time into the exit-side atmosphere substitution structure 42, with the saggars 2 arranged side-by-side in the Y direction aligned when conveying the saggars 2 from the heat treatment unit 12 into the exit-side atmosphere substitution structure 42. Here, the configuration of the conveying device (24, 26) aligning the plural saggars 2 arranged side-by-side in the Y direction will be described later in detail.

The controller 28 is composed of a computer which comprises for example a CPU, a ROM, a RAM. As illustrated in FIG. 4, the controller 28 is connected to the heaters 16a, 16b, the roller drive devices 26, door pressing devices 56 (to be described later), and a door lifting device 74 (to be described later), and thus controls the heaters 16a, 16b, the roller drive devices 26, the door pressing devices 56, and the door lifting device 74.

As illustrated in FIG. 1, the second heat treatment furnace 10b is disposed parallel to the first heat treatment furnace 10a with an interval disposed therebetween in the Y direction. The second heat treatment furnace 10b is disposed such that a direction of conveying the saggars 2 is opposite from that of the first heat treatment furnace 10a. That is, the entrance 20b of the second heat treatment furnace 10b is disposed near the exit 22a of the first heat treatment furnace 10a, and the exit 22b of the second heat treatment furnace 10b is disposed near the entrance 20a of the first heat treatment furnace 10a. Due to this, the conveying direction of the saggars 2 in the first heat treatment furnace 10a (direction from −X direction toward the +X direction) and the conveying direction of the saggars 2 in the second heat treatment furnace 10b (direction from the +X direction to the −X direction) are opposite from each other. Also, as mentioned above, the second heat treatment furnace 10b has the substantially same configuration as that of the first heat treatment furnace 10a, and a detailed description about its configuration will be omitted.

Next, the first recovery device 82a and the second recovery device 82b will be described. The first recovery device 82a is arranged between the first heat treatment furnace 10a (in particular, the exit 22a of the first heat treatment furnace 10a) and the second supply device 80b. The first recovery device 82a recovers the treatment object which was heat-treated in the first heat treatment furnace 10a from the saggars 2. The second recovery device 82b is arranged between the second heat treatment furnace 10b (in particular, the exit 22b of the second heat treatment furnace 10b) and the first supply device 80a. The second recovery device 82b recovers the treatment object which was heat-treated in the second heat treatment furnace 10b from the saggars 2. The first recovery device 82a and the second recovery device 82b have a same configuration as each other. Due to this, hereafter, the first recovery device 82a will be described.

The first recovery device 82a is a device configured to recover the treatment object (i.e., powder) which was heat-treated in the first heat treatment furnace 10a from each saggar 2. Here, the first recovery device 82a simply needs to be configured to recover the powder from the saggars 2, and a specific configuration thereof is not limited in particular. For example, the first recovery device 82a comprises an invert and recover part which inverts the saggar 2 in the up-down direction for recovery and an air recover part which removes and recovers the treatment object (in the present embodiment, powder) stuck on a surface of the saggar 2 by air. The invert and recover part transfers the powder in the saggar 2 into a recovery container by inverting the saggar 2 in the up-down direction. Due to this, almost all the powder accommodated in the saggar 2 is transferred to the recovery container. The invert and recover part comprises a handling part for inverting the saggar 2 in the up-down direction and the handling part is constituted of a ceramic material. The handling part makes contact with the saggar 2. By forming the handling part of a ceramic material, heat resistance of the handling part can be ensured, and thus the handling part is capable of grasping the high-temperature saggar 2. Thereafter, the invert and recover part inverts the saggar 2 in the up-down direction again to return the saggar 2 to the original orientation. The air recover part is used after the powder in the saggar 2 has been recovered by the invert and recover part. The air recover part blows air onto an internal surface of the saggar 2 and suctions the air etc., in the saggar 2. By blowing the air onto the internal surface of the saggar 2, the powder stuck onto the internal surface of the saggar 2 is detached from the internal surface. When the air etc. in the saggar 2 is suctioned while blowing the air onto the internal surface of the saggar 2, the powder detached from the internal surface of the saggar 2 is also suctioned with the air. Due to this, the powder remaining on the internal surface of the saggar 2 is recovered, and a recovery rate of the powder is increased. Here, although the first recovery device 82a comprises the air recover part in the above example, such configuration does not cast any limitation. For example, a configuration where the powder remaining on the internal surface of the saggar 2 is recovered by being detached by a rotary brush may be implemented.

As described above, each saggar 2 is circulated and conveyed between the first supply device 80a, the first heat treatment furnace 10a, the first recovery device 82a, the second supply device 80b, the second heat treatment furnace 10b, and the second recovery device 82b. Roller conveyors are disposed each between the first supply device 80a, the first heat treatment furnace 10a, the first recovery device 82a, the second supply device 80b, the second heat treatment furnace 10b, and the second recovery device 82b, and the respective roller conveyors transport the saggar 2. Here, the saggar 2 simply needs to be conveyed by circulating between the first supply device 80a, the first heat treatment furnace 10a, the first recovery device 82a, the second supply device 80b, the second heat treatment furnace 10b, and the second recovery device 82b. Another conveying device different from the roller conveyors (e.g., belt conveyor) may be implemented.

In the present embodiment, the first heat treatment furnace 10a and the second heat treatment furnace 10b are disposed such that the conveying direction of the saggar 2 in the first heat treatment furnace 10a and the conveying direction of the saggar 2 in the second heat treatment furnace 10b are opposite from each other. That is, a distance between the exit 22a of the first heat treatment furnace 10a and the entrance 20b of the second heat treatment furnace 10b is shortened, and also a distance between the exit 22b of the second heat treatment furnace 10b and the entrance 20a of the first heat treatment furnace 10a is shortened. Due to this, the saggar 2 which was used in the heat treatment in the first heat treatment furnace 10a can be conveyed into the second heat treatment furnace 10b with the temperature of the saggar 2 kept high. Likewise, the saggar 2 which was used in the heat treatment in the second heat treatment furnace 10b can be conveyed into the first heat treatment furnace 10a with the temperature of the saggar 2 kept high. Due to this, because a time for raising the temperature of the saggar 2 in each of the heat treatment furnaces 10a, 10b can be shortened, a length of the heat treatment unit 12 in each of the first heat treatment furnace 10a and the second heat treatment furnace 10b can be shortened. As a result of this, energy required for heating the treatment object can be reduced. Further, since the saggar 2 is conveyed from the first heat treatment furnace 10a and the second heat treatment furnace 10b with the temperature of the saggar 2 kept high, a cooling unit does not need to be arranged on the exit side of the heat treatment unit 12 of each of the first heat treatment furnace 10a and the second heat treatment furnace 10b. Alternatively, even if the cooling unit is arranged, a length of the cooling unit can be made short because it is not necessary to cool the saggar 2 to a lower temperature. In a conventional heat treatment furnace for example, the saggar 2 was conveyed out of the heat treatment furnace after the saggar 2 is cooled until the temperature of the saggar 2 lowers to approximately 200 degrees. However, in the heat treatment system 1 according to the present embodiment, when the saggar 2 is cooled until the temperature of the saggar 2 lowers to 400 degrees, the saggar 2 can be conveyed out of each of the first heat treatment furnace 10a and the second heat treatment furnace 10b. As such, the length of each of the first heat treatment furnace 10a and the second heat treatment furnace 10b can be shortened, by which a use of the atmospheric gas in each of the first heat treatment furnace 10a and the second heat treatment furnace 10b can be decreased.

Here, the entrance-side atmosphere substitution structure 40 and the exit-side atmosphere substitution structure 42 will be described. As mentioned above, the first heat treatment furnace 10a and the second heat treatment furnace 10b have the same configuration as each other except that the conveying directions for the saggar 2 are opposite from each other. Hereafter, the entrance-side atmosphere substitution structure 40 and the exit-side atmosphere substitution structure 42 of the first heat treatment furnace 10a will be described. The entrance-side atmosphere substitution structure 40 is disposed between the entrance 20a of the first heat treatment furnace 10a and the heat treatment unit 12, whereas the exit-side atmosphere substitution structure 42 is disposed between the heat treatment unit 12 and the exit 22a of the first heat treatment furnace 10a. Each of the entrance-side atmosphere substitution structure 40 and the exit-side atmosphere substitution structure 42 is used for maintaining the atmosphere in the internal space of the heat treatment unit 12.

As mentioned above, in the heat treatment system 1 according to the present embodiment, the saggar 2 which was used in the heat treatment in one of the two heat treatment furnaces 10a, 10b is conveyed into the other of the heat treatment furnaces 10b, 10a with the temperature of the saggar 2 kept high. Due to this, the entrances 20a, 20b of the heat treatment furnaces 10a, 10b need to have a configuration which allows the high-temperature saggar 2 to be conveyed in, and the exits 22a, 22b of the heat treatment furnaces 10a, 10b need to have a configuration which allows the high-temperature saggar 2 to be conveyed out. Due to this, the entrance-side atmosphere substitution structure 40 has a configuration which allows the high-temperature saggar 2 to be conveyed into the heat treatment unit 12, whereas the exit-side atmosphere substitution structure 42 has a configuration which allows the high-temperature saggar 2 to be conveyed out of the heat treatment unit 12. The entrance-side atmosphere substitution structure 40 and the exit-side atmosphere substitution structure 42 have a substantially same configuration as each other. Due to this, hereafter, the exit-side atmosphere substitution structure 42 disposed on an exit 22a side of the first heat treatment furnace 10a will be described.

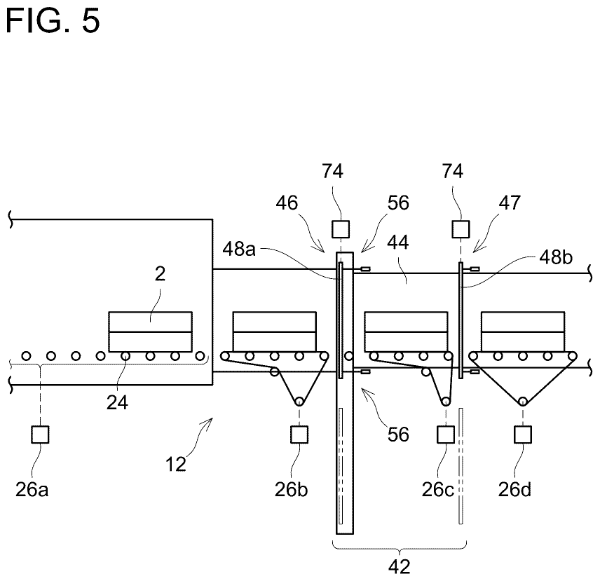

As illustrated in FIG. 5, the exit-side atmosphere substitution structure 42 comprises a substitution chamber 44, a heat treatment-side scaling structure 46, and an outer-side scaling structure 47.

The substitution chamber 44 is disposed downstream of the heat treatment unit 12 and adjacent to the heat treatment unit 12. A door 48a is disposed between the substitution chamber 44 and the heat treatment unit 12, and a door 48b is disposed between the substitution chamber 44 and the exit 22a. Each of the doors 48a, 48b is configured to be opened and closed, and is configured to be closed so as to seal between the substitution chamber 44 and the heat treatment unit 12 and between the substitution chamber 44 and the exit 22a. Here, the configurations of the doors 48a, 48b to seal between the substitution chamber 44 and the heat treatment unit 12 and between the substitution chamber 44 and the exit 22a will be described later in detail. The substitution chamber 44 is installed with the conveying rollers 24. The saggar 2 is conveyed from the heat treatment unit 12 to the substitution chamber 44 by the conveying rollers 24. The substitution chamber 44 has an air supply opening from which a gas that is same as the atmospheric gas supplied to the heat treatment unit 12 is supplied. In the substitution chamber 44, the atmosphere is substituted between the inside of the heat treatment unit 12 and outside of the first heat treatment furnace 10a. By the substitution chamber 44 being arranged, air outside the first heat treatment furnace 10a can be suppressed from entering the heat treatment unit 12, and the atmospheric gas in the heat treatment unit 12 can be suppressed from leaking outside of the first heat treatment furnace 10a.

Here, conveying of the saggar 2 in the substitution chamber 44 will be described. The conveying rollers 24 disposed near the substitution chamber 44 of the heat treatment unit 12 are configured to be driven by another roller drive device 26 (hereafter, referred to as “roller drive device 26b”) different from the roller drive device 26 (hereafter, referred to as “roller drive device 26a”) configured to drive other conveying rollers 24 in the heat treatment unit 12. Further, the conveying rollers 24 disposed in the substitution chamber 44 are configured to be driven by another roller drive device 26 (hereafter, referred to as “roller drive device 26c”) different from the roller drive devices 26a, 26b configured to drive the conveying rollers 24 in the heat treatment unit 12. Further, the conveying rollers 24 are also disposed outside the substitution chamber 44 (i.e., outside the first heat treatment furnace 10a), and are configured to driven by another roller drive device 26 (hereafter, referred to as “roller drive device 26d”) different from the roller drive devices 26a, 26b, 26c. The roller drive devices 26a, 26d are configured to drive the respective conveying rollers 24 so that they rotate at a substantially same speed. The roller drive devices 26b, 26c are configured to change rotary speeds of the conveying rollers 24 by adjusting their outputs.

A mechanism configured to align the plurality of saggars 2 disposed side-by-side in the Y direction is arranged near the substitution chamber 44 of the heat treatment unit 12. Specifically, a stopper (not illustrated) is disposed near a boundary of the substitution chamber 44 of the heat treatment unit 12. The stopper is configured to move in the up-down direction. When the stopper is located above, the stopper projects upward from the conveying rollers 24 to contact side surfaces of the plural saggars 2 on a conveying direction side, and when the stopper retracts downward, the stopper is placed below the conveying rollers 24. The plurality of saggars 2 arranged side-by-side in the Y direction aligns by positioning the stopper above.

The saggars 2 are conveyed in the heat treatment unit 12 by the conveying rollers 24 connected to the roller drive device 26a, and the saggars 2 are conveyed near the substitution chamber 44 by the conveying rollers 24 connected to the roller drive device 26b. At this occasion, the stopper is positioned above the conveying rollers 24, the door 48a is closed, and the door 48b is also closed. When the saggars 2 have been conveyed near the boundary of the substitution chamber 44, the plurality of saggars 2 arranged side-by-side in the Y direction are aligned by the stopper. A sensor is disposed near the stopper, and once all the saggars 2 arranged side-by-side in the Y direction are detected by the sensor, the door 48a is opened. Then, when the door 48a is opened, the output of the roller drive devices 26b, 26c are increased, and also the stopper is moved downward. At this occasion, the roller drive devices 26b, 26c drive the respective conveying rollers 24 so that the conveying rollers 24 rotate at the substantially same speed. The roller drive devices 26b, 26c rotate at a higher speed by the outputs of the roller drive devices 26b, 26c being increased. Then, the saggars 2 are conveyed into the substitution chamber 44 at the higher speed by the conveying rollers 24 that are connected to the roller drive device 26b, and in the substitution chamber 44, the saggars 2 are conveyed at the higher speed by the conveying rollers 24 connected to the roller drive device 26c. Once the saggars 2 have been conveyed to a predetermined location in the substitution chamber 44, the roller drive devices 26b, 26c stop rotating the conveying rollers 24. Then, the saggars 2 stop at the predetermined location in the substitution chamber 44. Thereafter, the door 48a is closed. Due to this, the saggars 2 are accommodated in the substitution chamber 44, and the two doors 48a, 48b are now both closed. Thereafter, when a predetermined duration has elapsed, the door 48b is opened, and the conveying rollers 24 within the substitution chamber 44 are rotated by the roller drive device 26c. At this occasion, the roller drive devices 26c, 26d drive the respective conveying rollers 24 so that the conveying rollers 24 rotate at a substantially same speed. Then, the saggars 2 are conveyed out of the substitution chamber 44 (i.e., out of the first heat treatment furnace 10a) by the conveying rollers 24 within the substitution chamber 44, and further conveyed entirely out of the substitution chamber 44 by the conveying rollers 24 connected to the roller drive device 26d.

Next, the heat treatment-side sealing structure 46 and the outer-side sealing structure 47 will be described. The heat treatment-side sealing structure 46 is disposed between the substitution chamber 44 and the heat treatment unit 12, and is configured to seal between the substitution chamber 44 and the heat treatment unit 12. The outer-side sealing structure 47 is disposed between the substitution chamber 44 and outside of the first heat treatment furnace 10a, and is configured to seal between the substitution chamber 44 and the outside of the first heat treatment furnace 10a. The heat treatment-side sealing structure 46 and the outer-side sealing structure 47 have a same configuration. Due to this, hereafter, the heat treatment-side sealing structure 46 will be described in detail.

As illustrated in FIGS. 5 to 9, the heat treatment-side sealing structure 46 comprises the door 48a (hereafter, will be referred to as simply “door 48”), the door pressing devices 56, chains 70, a shaft 72, and the door lifting device 74.

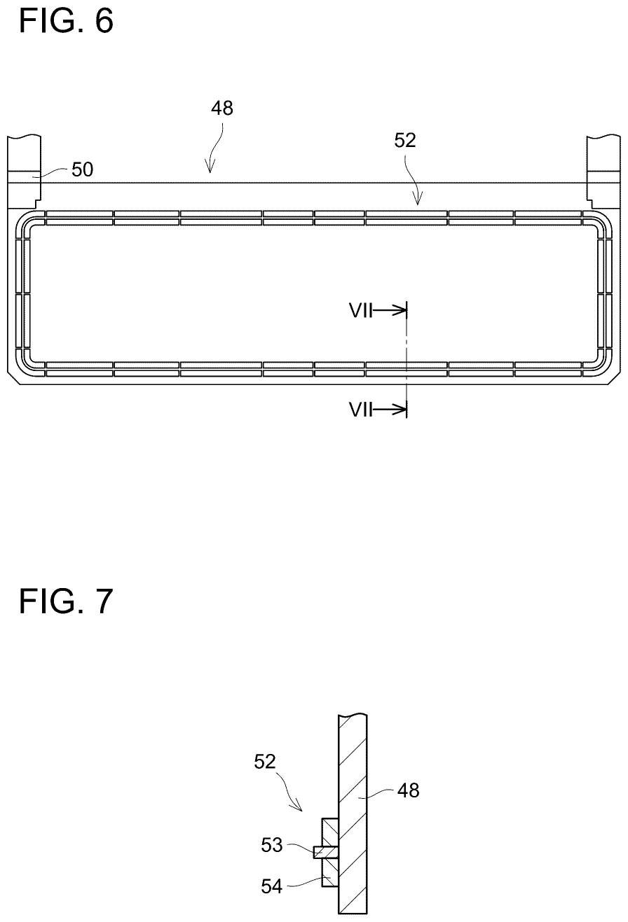

The door 48 is arranged between the substitution chamber 44 and the heat treatment unit 12. As shown in FIG. 6, the door 48 has a substantially rectangular shape, and is made larger than an internal surface of the heat treatment unit 12 as the heat treatment unit 12 is cut along a direction perpendicular to the conveying direction (see FIG. 5). Chain hanging portions 50 (to be described later in detail) are connected to an upper part of the door 48. The chains 70 (to be described later in detail) are connected to the chain hanging portions 50. The door 48 is connected to the chains 70 via the chain hanging portions 50. The door 48 is configured to be moved by the chains 70 in the up-down direction. When the door 48 is positioned upward, the door 48 is positioned between the heat treatment unit 12 and the substitution chamber 44, and closes between the heat treatment unit 12 and the substitution chamber 44. That is, when the door 48 is positioned upward, the door 48 comes into a state of being closed. On the other hand, when the door 48 is moved downward, the door 48 is positioned below the conveying rollers 24, by which the heat treatment unit 12 and the substitution chamber 44 are communicated. That is, when the door 48 is positioned downward, the door 48 falls to a state of being opened.

The door 48 is constituted of a cement-based or calcium silicate-based heat insulating material in a plate shape. As described above, the first heat treatment furnace 10a discharges the saggar 2 with the temperature kept high. Accordingly, the heat treatment unit 12 has its atmosphere temperature high also on or near the boundary between the heat treatment unit 12 and the substitution chamber 44. The door 48 is exposed to a space of the heat treatment unit 12 when the door 48 is closed. By the door 48 being constituted of the cement-based or calcium silicate-based heat insulating material in a plate shape, heat resistance of the door 48 can be ensured, and also thermal deformation of the door 48 can be suppressed.

As illustrated in FIGS. 6 and 7, the door 48 comprises a sealing structure 52. The scaling structure 52 is arranged on a surface of the door 48 on a heat treatment unit 12 side, and is arranged so that the sealing structure 52 conform with an end surface of the heat treatment unit 12 on a substitution chamber 44 side when the door 48 is arranged between the heat treatment unit 12 and the substitution chamber 44 (when the door 48 is closed). That is, the scaling structure 52 is disposed in a circumferential direction along the end surface of the heat treatment unit 12 on an exit side. A frame (not illustrated) arranged in the circumferential direction along the end surface is disposed on the end surface of the heat treatment unit 12 on the exit side, and the sealing structure 52 is arranged so as to make contact with the frame. That is, a surface of the sealing structure 52 on the heat treatment unit 12 side has a contact surface which makes contact with the frame.

The sealing structure 52 comprises a sealing portion 53 and a retaining member 54. The sealing portion 53 is composed of a single member which extends continuously in the circumferential direction. The sealing portion 53 is arranged entirely along the circumferential direction of the sealing structure 52. The sealing portion 53 is constituted of a fiber-based scaling material. The retaining member 54 is fixed to the door 48, and is disposed along the scaling portion 53. Specifically, the retaining member 54 is disposed so as to sandwich the sealing portion 53 on the surface of the door 48 on the heat treatment unit 12 side. The retaining member 54 retains the sealing portion 53. In the present embodiment, the retaining member 54 is composed of plural members divided in the circumferential direction. Here, the retaining member 54 may be composed of a single member which extends continuously in the circumferential direction. The scaling portion 53 allows to seal between the heat treatment unit 12 and the door 48 when the door 48 is closed. Also, by the sealing portion 53 being constituted of a fiber-based sealing material, heat resistance of the sealing portion 53 can be ensured. In the present embodiment also, a space is defined within the frame (not shown) disposed on the end surface of the heat treatment unit 12, and cooling medium is accommodated in the space. The cooling medium (e.g., air or water) is accommodated within the frame, by which the frame can be cooled, resulting in cooling the door 48. In the present embodiment, the sealing structure 52 is disposed on the door 48, but the scaling structure may be disposed on a surface of the frame arranged on the end surface of the heat treatment unit 12, in which the surface of the frame faces the door 48.

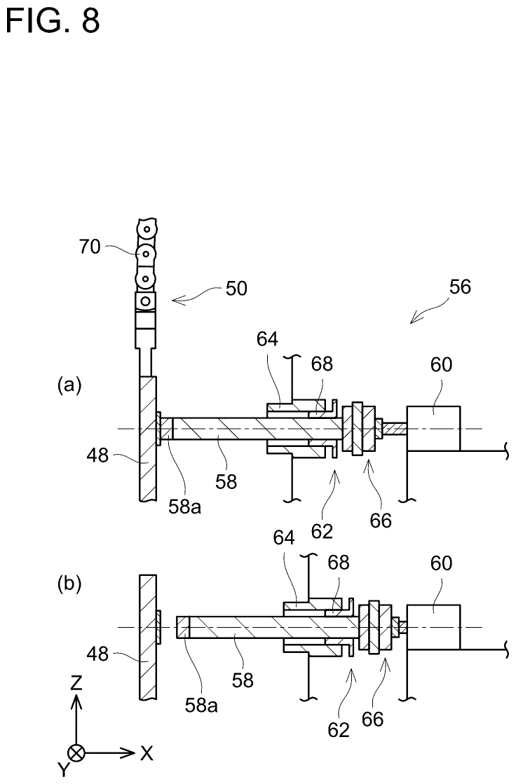

The door pressing devices 56 are positioned in an upper part of the substitution chamber 44 and are configured to press the door 48 toward the heat treatment unit 12 with the door 48 closed. As illustrated in FIG. 5, the door pressing devices 56 are arranged at two spots, i.e., near an upper end of the door 48 and near a lower end of the door 48, and are configured to press the door 48 at and near its upper end and at and near its lower end. As illustrated in FIG. 8(a) and FIG. 8(b), each of the door pressing devices 56 comprises a pressing portion 58, a cylinder 60, and a coupling structure 62 that couples the pressing portion 58 and the cylinder 60.

The pressing portion 58 is cylindrical, and disposed such that its axis line coincides with the conveying direction. The pressing portion 58 is disposed near the door 48. The pressing portion 58 is constituted of a ceramic material. The cylinder 60 is connected to the pressing portion 58 via the coupling structure 62. The cylinder 60 is disposed on a same line as the axis line of the pressing portion 58, and is disposed at a spot farther away from the door 48 than the pressing portion 58 (+X direction). The cylinder 60 is configured to press the pressing portion 58 toward the door 48 via the coupling structure 62. When the pressing portion 58 is pressed by the cylinder 60 with the door 48 being at the closed position as illustrated in FIG. 8(a), the pressing portion 58 makes contact with a surface of the door 48 opposite from the heat treatment unit 12 side (at the heat treatment-side sealing structure 46, surface on a substitution chamber 44 side). Sealing property of the scaling portion 53 can be improved by allowing the pressing portion 58 to press the door 48 toward the heat treatment unit 12. The pressing portion 58 also makes contact with the door 48. As described above, the temperature of the door 48 becomes high in the closed state. Heat resistance of the pressing portion 58 can be ensured by forming the pressing portion 58 of a ceramic material. Although in the present embodiment, an entirety of the pressing portion 58 is constituted of the ceramic material, the pressing portion 58 is not limited to this configuration. In the pressing portion 58, in particular, a tip portion 58a needs to have a high heat resistance, and the tip portion 58a only may be constituted of a ceramic material.

The coupling structure 62 comprises a bush 64, a coupler 66, and a sealing portion 68. The bush 64 is attached to a wall of the substitution chamber 44, and an end of the pressing portion 58 on a cylinder 60 side is slidably inserted into the bush 64. The bush 64 is constituted of a heat-resistant material. The coupler 66 is disposed between the pressing portion 58 and the cylinder 60. In the present embodiment, the coupler 66 is a floating joint. A gap between the bush 64 and the pressing portion 58 is sealed by the sealing portion 68. The sealing portion 68 is constituted of a fiber-based sealing material. In the coupling structure 62, the bush 64 and the scaling portion 68 are positioned at a spot close to the pressing portion 58, that is, at a spot relatively close to the door 48. Due to this, temperatures of the bush 64 and the scaling portion 68 are prone to becoming high. Heat resistance of the bush 64 and the sealing portion 68 can be ensured by forming the bush 64 and the sealing portion 68 of a heat-resistant material. Contrary to this, because the cylinder 60 is coupled to the pressing portion 58 via the coupling structure 62, the cylinder 60 is arranged at a spot relatively remote from the pressing portion 58, that is, the door 48. The cylinder 60 is arranged by the coupling structure 62 being interposed, as a result of which the cylinder 60 can be suppressed from being thermally affected.

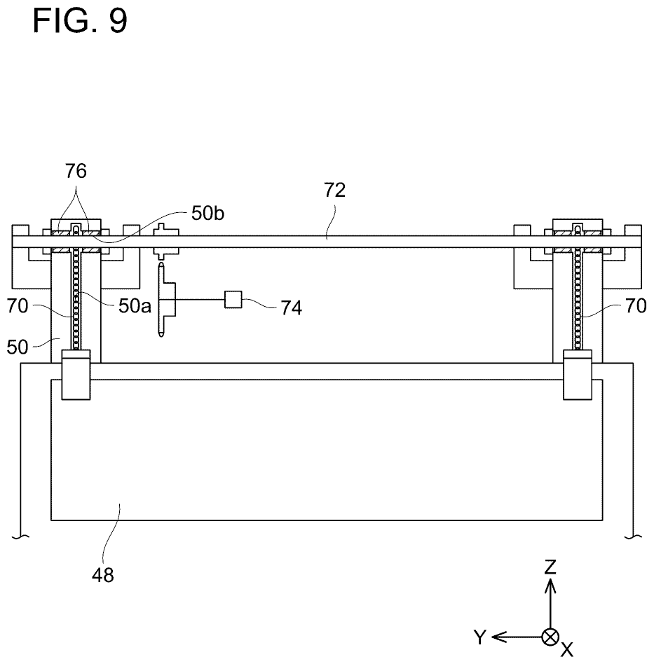

The chains 70 are used for opening and closing the door 48. As illustrated in FIG. 9, the chains 70 are disposed in the chain hanging portions 50. The chain hanging portions 50 are disposed above the door 48, and are arranged on a ceiling wall of the substitution chamber 44. Specifically, two chain hanging portions 50 are arranged on the ceiling wall of the substitution chamber 44. The two chain hanging portions 50 are located above the door 48, and one of the two chain hanging portions 50 is arranged near an end of the door 48 in +Y direction and the other of the two chain hanging portions 50 is arranged near an end of the door 48 in-Y direction. Each of the chain hanging portions 50 extends upward from the ceiling wall of the substitution chamber 44. Each of the chain hanging portions 50 comprises a hole 50a extending in the up-down direction and a through hole 50b extending parallel to an upper surface of the door 48 (that is, in Y direction). A lower end of the hole 50a is open to inside of the substitution chamber 44 and an upper end of the hole 50a is in communication with the through hole 50b. The chain 70 is arranged in the hole 50a. The through hole 50b is defined near an upper end of each chain hanging portion 50. The shaft 72 penetrates in the through holes 50b. A sealing portion 76 is arranged in each through hole 50b, and a gap between the shaft 72 and the chain hanging portion 50 is sealed by the sealing portion 76. Due to this, the inside of the substitution chamber 44 is prevented from being communicated through the holes 50a and the through holes 50b with outside of the substitution chamber 44.

Each chain 70 has its lower end connected to the door 48 and its upper end connected to the shaft 72. Specifically, the shaft 72 has a sprocket disposed at a connection between the shaft 72 and each chain 70, and that chain 70 is connected to the sprocket. The shaft 72 has its opposing ends respectively penetrating the two through holes 50b of the two chain hanging portions 50, and a center part of the shaft 72 is disposed above the door 48. The shaft 72 is disposed above the door 48 and disposed along the upper surface of the door 48. The shaft 72 is supported rotatably about its axis line, and configured to rotate by driving force from the door lifting device 74 transmitted thereto. The door lifting device 74 is a drive device (e.g., motor) configured to drive the shaft 72. The door lifting device 74 is connected to the shaft 72 via a power transmission mechanism. The shaft 72 is configured to rotate when the driving force from the door lifting device 74 is transmitted to the shaft 72 via the power transmission mechanism (e.g., mechanism by a sprocket and chain). The door lifting device 74 is configured to rotate the shaft 72 bidirectionally (forward direction and reverse direction) by adjusting its output. Hereafter, one of the rotating directions of the shaft 72 will be denoted “first direction” and an opposite direction from the first direction will be denoted “second direction”.

When the shaft 72 is rotated in the first direction, the chains 70 connected to the shaft 72 wind about the sprockets of the shaft 72. That is, the shaft 72 wind up the chains 70 by rotating the shaft 72 in the first direction. The lower ends of the chains 70 are connected to the door 48. Due to this, the door 48 moves upward when the shaft 72 winds up the chains 70. Contrary to this, when the shaft 72 is rotated in the second direction, the chains 70 that have been wound about the sprockets of the shaft 72 move downward. That is, the shaft 72 winds down the chains 70 by rotating the shaft 72 in the second direction. The door 48 moves downward when the shaft 72 winds down the chains 70.

As mentioned above, the door 48 is configured to move in the up-down direction by the chains 70. That is, the door 48 is retained in a state of being hung freely by the chains 70. Further, as mentioned above, the couplers 66 of the door pressing devices 56 are floating joints. The heat resistance of the door 48 is ensured because the door 48 is constituted of a ceramic material, but the door 48 can possibly slightly be deformed thermally by being exposed to high temperature heat. For example, in a case where the door 48 is opened and closed by sliding, if the door 48 thermally deforms and thus distorts, a part of the sealing portion 53 disposed in the scaling structure 52 would become unable to contact the end of the heat treatment unit 12, as a result of which sealing property of the scaling portion 53 may be decreased. In the present embodiment, because the door 48 is hung by the chains 70 and also the floating joints are implemented in the door pressing devices 56, even if the door 48 thermally deforms, the entirety of the scaling portion 53 can be made to contact the end of the heat treatment unit 12 by pressing the door 48 with the door pressing devices 56. Due to this, scaling property of the scaling portion 53 (i.e., the door 48) can be ensured.

Further, the through holes 50b defined in the chain hanging portions 50 for the shaft 72 to penetrate can be made smaller by the shaft 72 winding the chains 70 up and down. Due to this, an area for arranging the sealing portions 76 can be made smaller. If, for example, chain(s) are configured to be moved in the up-down direction by cylinder(s), guide(s) would be arranged at chain hanging portion(s), and the guide(s) need to be sealed. In this case, the guide(s) need to have a length conforming to a dimension of the door 48 in the up-down direction, and a relatively large area in the up-down direction needs to be sealed. In the present embodiment, because the shaft 72 is used to wind the chains 70 up and down, an area which is sealed can be made smaller.

Some of points to be noted regarding the heat treatment system 1 described in the embodiment will be described. The substitution chamber 44 in the embodiment is an example for “substitution unit”, the door pressing devices 56 in the embodiment are an example for “pressing device”, the coupling structures 62 in the embodiment are an example for “coupling portion”, and the door lifting device 74 in the embodiment is an example for “drive device”.

Specific examples of the disclosure herein have been described in detail, however, these are mere exemplary indications and thus do not limit the scope of the claims. The art described in the claims includes modifications and variations of the specific examples presented above. Technical features described in the description and the drawings may technically be useful alone or in various combinations, and are not limited to the combinations as originally claimed. Further, the purpose of the examples illustrated by the present description or drawings is to satisfy multiple objectives simultaneously, and satisfying any one of those objectives gives technical utility to the present disclosure.

What is claimed is:

1. A heat treatment system comprising: a first supply device; a first heat treatment furnace; a first recovery device; a second supply device; a second heat treatment furnace; and a second recovery device,
wherein the first supply device is disposed near the second recovery device and configured to supply a treatment object to a saggar conveyed from the second recovery device,
the first heat treatment furnace comprises:
an entrance disposed near the first supply device and through which the saggar supplied with the treatment object by the first supply device is conveyed into the first heat treatment furnace;
an exit through which the entered saggar is conveyed out of the first heat treatment furnace;
a heat treatment unit disposed between the entrance and the exit of the first heat treatment furnace, and configured to heat-treat the treatment object supplied in the saggar while the saggar is conveyed from the entrance to the exit of the first heat treatment furnace; and
a first conveyor configured to convey the saggar in a first direction, the first direction being a direction from the entrance to the exit of the first heat treatment furnace,
the first recovery device is disposed near the exit of the first heat treatment furnace and configured to recover the treatment object that has been heat-treated in the first heat treatment furnace from the saggar,
the second supply device is disposed near the first recovery device and configured to supply a new treatment object to the saggar from which the treatment object has been recovered by the first recovery device,
the second heat treatment furnace comprises:
an entrance disposed near the second supply device and through which the saggar supplied with the treatment object by the second supply device is conveyed into the second heat treatment furnace;
an exit through which the entered saggar is conveyed out of the second heat treatment furnace;
a heat treatment unit disposed between the entrance and the exit of the second heat treatment furnace, and configured to heat-treat the treatment object supplied in the saggar while the saggar is conveyed from the entrance to the exit of the second heat treatment furnace; and
a second conveyor configured to convey the saggar from the entrance to the exit of the second heat treatment furnace in a second direction opposite to the first direction,
the second recovery device is disposed near the exit of the second heat treatment furnace and configured to recover the treatment object that has been heat-treated in the second heat treatment furnace from the saggar,
each of the first heat treatment furnace and the second heat treatment furnace further comprises a substitution unit disposed between the heat treatment unit of a corresponding heat treatment furnace and the exit of the corresponding heat treatment furnace, and configured to isolate the heat treatment unit of the corresponding heat treatment furnace from outside of the exit of the corresponding heat treatment furnace, and
the substitution unit comprises doors constituted of a heat insulating material and configured to be opened and closed, and disposed between the heat treatment unit and the substitution unit of the corresponding heat treatment furnace and between the substitution unit and the exit of the corresponding heat treatment furnace.

2. The heat treatment system according to claim 1, wherein each of the first heat treatment furnace and the second heat treatment furnace further comprises:
a contact surface disposed between the heat treatment unit and at least one of the doors disposed in the substitution unit, and contacting an entire periphery of the at least one of the doors when the at least one of the doors is closed, and
a pressing device disposed outside the substitution unit and configured to press the door toward the contact surface when the door is closed.

3. The heat treatment system according to claim 2, wherein the contact surface comprises a seal sealing between the door and the contact surface, and
the seal is constituted of a fiber-based seal material.

4. The heat treatment system according to claim 2, wherein the pressing device comprises:
a pressing portion configured to contact the door;
a cylinder disposed closer to the exit than the pressing portion is and configured to press the pressing portion; and
a coupling portion configured to connect the pressing portion and the cylinder, and
the pressing portion and the coupling portion are constituted of a heat-resistant material.

5. The heat treatment system according to claim 4, wherein the pressing portion is constituted of a ceramic material.

6. The heat treatment system according to claim 4, wherein each of the first heat treatment furnace and the second heat treatment furnace further comprises a chain connected to an upper end of the at least one of the doors disposed in the substitution unit and supporting the at least one of the doors.

7. The heat treatment system according to claim 6, wherein each of the first heat treatment furnace and the second heat treatment furnace further comprises:
a shaft configured to wind up the chain by rotating the shaft in a third direction and wind down the chain by rotating the shaft in a fourth direction opposite to the third direction; and
a drive device configured to rotate the shaft,
the shaft is disposed above the chain so that its axis is horizontal and perpendicular to a conveying direction, and
the door moves upward as the shaft winds up the chain and moves downward as the shaft winds down the chain.

8. The heat treatment system according to claim 7, wherein the door is configured to be opened by moving downward.

9. The heat treatment system according to claim 1, wherein each of the first heat treatment furnace and the second heat treatment furnace further comprises an entrance-side substitution unit disposed between the heat treatment unit of a corresponding heat treatment furnace and the entrance of the corresponding heat treatment furnace, and configured to isolate the heat treatment unit of the corresponding heat treatment furnace from an outside of the entrance of the corresponding heat treatment furnace, and
the entrance-side substitution unit comprises doors constituted of a heat insulating material and configured to be opened and closed, and disposed between the heat treatment unit and the entrance-side substitution unit of the corresponding heat treatment furnace and between the entrance-side substitution unit and the entrance of the corresponding heat treatment furnace.

10. An atmosphere substitution structure disposed in a heat treatment furnace comprising a heat treatment unit and configured to maintain atmosphere in an internal space of the heat treatment unit, wherein the heat treatment furnace comprises:
an entrance through which a saggar supplied with a treatment object is conveyed into the heat treatment furnace;
the heat treatment unit configured to heat-treat the treatment object supplied in the saggar that has been conveyed through the entrance;
an exit through which the saggar supplied with the treatment object that has been heat-treated by the heat treatment unit is conveyed out of the heat treatment furnace; and
a conveyor configured to convey the saggar from the entrance to the exit,
the atmosphere substitution structure comprises:
a substitution chamber disposed between the heat treatment unit and the exit;
a first door disposed between the substitution chamber and the heat treatment unit; and
a second door disposed between the substitution chamber and the exit,
wherein each of the first door and the second door is constituted of a heat insulating material.
